(19) United States
(12) Patent Application Publication
(10) Pub. No.: US 2026/0066453 A1
(43) Pub. Date: Mar. 5, 2026

(54) ELECTRIC POWER STORAGE APPARATUS

(71) Applicant: TOYOTA JIDOSHA KABUSHIKI KAISHA, Toyota-shi (JP)

(72) Inventor: Takuya MORIOKI, Nagoya-shi (JP)

(73) Assignee: TOYOTA JIDOSHA KABUSHIKI KAISHA, Toyota-shi (JP)

(21) Appl. No.: 19/184,297

(22) Filed: Apr. 21, 2025

(30) Foreign Application Priority Data
Aug. 30, 2024 (JP) 2024-148269

(51) Int. Cl. H01M 50/383; H01M 50/204; H01M 50/271; H01M 50/289; H01M 50/358

(52) U.S. Cl. CPC H01M 50/383; H01M 50/204; H01M 50/271; H01M 50/289; H01M 50/358

(57) ABSTRACT

An electric power storage apparatus includes a first electric power storage module, a second electric power storage module, and a reinforcement member disposed between these electric power storage modules. The reinforcement member includes a first wall section facing the first electric power storage module and a second wall section facing the second electric power storage module. A hollow section is provided between the first and second wall sections. A first space is provided between the first electric power storage module and the reinforcement member. A first hole section is provided on the first wall section. The first hole section communicates between the first space and the hollow section. A second space is provided between the second electric power storage module and the reinforcement member. A second hole section is provided on the second wall section. The second hole section communicates between the second space and the hollow section.

### CROSS-REFERENCE TO RELATED APPLICATION

This application claims priority to Japanese Patent Application No. 2024-148269 filed on Aug. 30, 2024. The disclosure of the above-identified application, including the specification, drawings, and claims, is incorporated by reference herein in its entirety.

### BACKGROUND

### 1. Technical Field

The present disclosure relates to an electric power storage apparatus.

### 2. Description of Related Art

For example, Japanese Unexamined Patent Application Publication No. 2024-080096 (JP 2024-080096 A) discloses an electric power storage apparatus including two electric power storage modules and a case that stores the two electric power storage modules. The two electric power storage modules are each disposed in a region defined by a bottom wall, a peripheral wall, and a cross member (reinforcement member).

### SUMMARY

A smoke discharge section is formed on each of the electric power storage modules. The smoke discharge section discharges gas in the electric power storage module in a case where the internal pressure of the electric power storage module increases. The gas includes electrically conductive foreign matter (debris). When the electric power storage module is disposed in the region defined by the reinforcement member and the like, the gas discharged from the electric power storage module remains in the region. The electrically conductive foreign matter is thus deposited in the region. When the electrically conductive foreign matter is deposited in the region in which the electric power storage module is disposed, thermal influence from the electrically conductive foreign matter causes thermal runaway in the electric power storage module.

An object of the present disclosure is to prevent thermal runaway in an electric power storage module.

An electric power storage apparatus according to an aspect of the present disclosure includes a first electric power storage module, a second electric power storage module adjacent to the first electric power storage module, and a reinforcement member disposed between the first electric power storage module and the second electric power storage module. A smoke discharge section configured to discharge gas in the first electric power storage module is provided lower than the middle of the first electric power storage module in the up-down direction. The reinforcement member includes a first wall section facing the first electric power storage module and a second wall section facing the second electric power storage module. A hollow section is provided between the first wall section and the second wall section. A first space is provided between the first electric power storage module and the reinforcement member and a first hole section is provided on the first wall section. The first hole section provides communication between the first space and the hollow section. A second space is provided between the second electric power storage module and the reinforcement member. A second hole section is provided on the second wall section. The second hole section provides communication between the second space and the hollow section.

The first hole section and the second hole section may be each provided lower than the middle of the reinforcement member in the up-down direction.

The electric power storage apparatus may further include a storage case configured to store the first electric power storage module and the second electric power storage module. The storage case includes an upper case and a lower case. The reinforcement member may extend between the first electric power storage module and the second electric power storage module along the bottom wall of the lower case. The position of the first hole section and the position of the second hole section may be deviated in the direction in which the reinforcement member extends.

According to the present disclosure, it is possible to prevent thermal runaway in an electric power storage module.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic exploded perspective view of an electric power storage apparatus according to an embodiment of the present disclosure;

FIG. 2 is a top view of inside of an electric power storage apparatus 100 illustrated in FIG. 1 from above the electric power storage apparatus 100 with an upper case 91 detached from the electric power storage apparatus 100;

FIG. 3 is a diagram schematically illustrating an electric power storage unit 110 illustrated in FIG. 1;

FIG. 4 is a sectional view taken along a line IV-IV in FIG. 2;

FIG. 5 is a sectional view taken along a line V-V in FIG. 2; and

FIG. 6 is a sectional view taken along a line VI-VI in FIG. 4.

### DETAILED DESCRIPTION OF EMBODIMENTS

Hereinafter, an embodiment and modification examples according to the present disclosure will be described with reference to the drawings. The following description denotes the same components by the same reference signs and does not repeatedly describe the components. It is to be noted that the embodiment and the modification examples described below may be selectively combined as appropriate.

### Embodiment

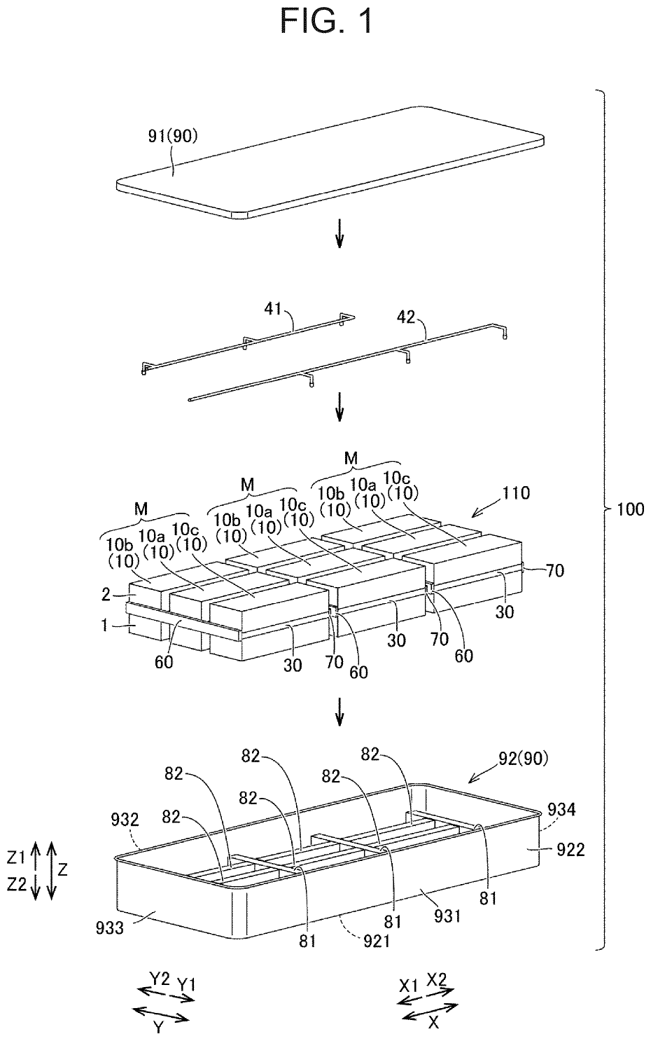

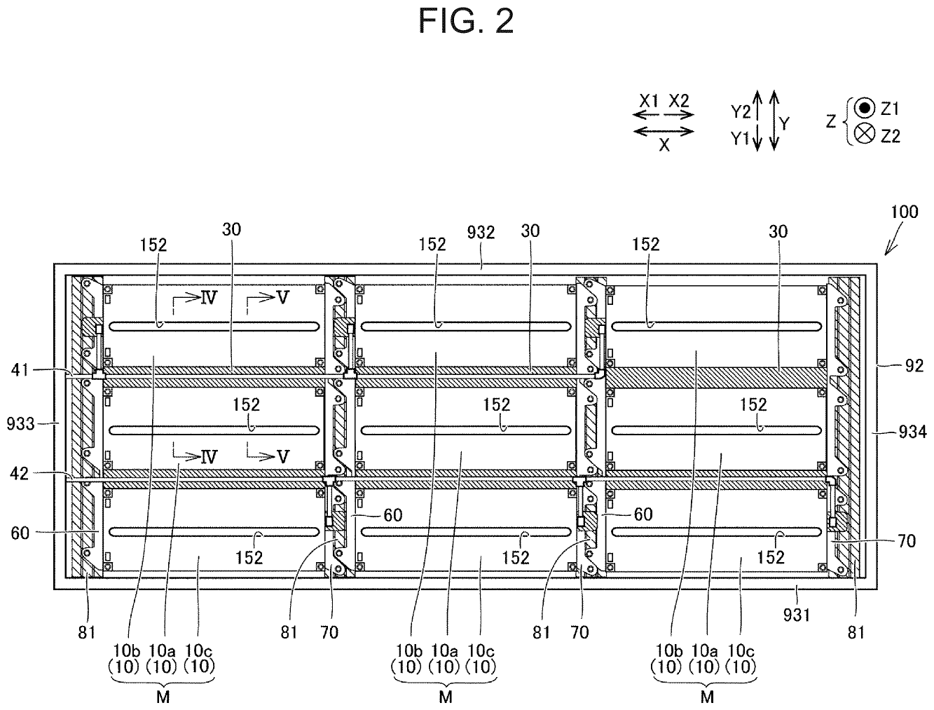

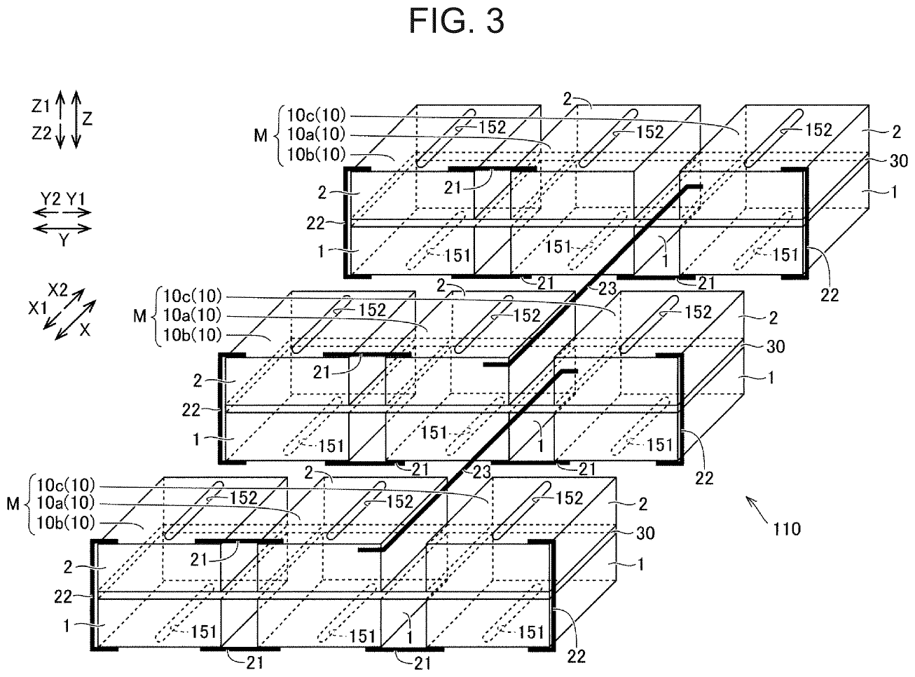

FIG. 1 is a schematic exploded perspective view of an electric power storage apparatus according to the embodiment of the present disclosure. FIG. 2 is a top view of the inside of an electric power storage apparatus 100 illustrated in FIG. 1 from above the electric power storage apparatus 100 with an upper case 91 detached from the electric power storage apparatus 100. FIG. 3 is a diagram schematically illustrating an electric power storage unit 110 illustrated in FIG. 1. It is to be noted that FIG. 1 omits smoke discharge sections 152 to make FIG. 1 easier to read. In addition, FIG. 2 hatches reinforcement members 81 and cooling devices 30 to make FIG. 2 easier to read.

When FIG. 1 and FIG. 2 are each referred to, the electric power storage apparatus 100 according to the present embodiment is, for example, a battery pack. As an example, the electric power storage apparatus 100 is mounted on a vehicle. The vehicle travels by using electric power stored in the electric power storage apparatus 100. Examples of the vehicle includes a hybrid electric vehicle, a plug-in hybrid electric vehicle, a fuel cell electric vehicle, and a battery electric vehicle. It is to be noted that the application of the electric power storage apparatus 100 is not limited to vehicle application. The electric power storage apparatus 100 may be mounted on an apparatus other than a vehicle and may store electric power for driving the apparatus.

In the present disclosure, an X direction, a Y direction, and a Z direction are orthogonal to each other. In a case where the electric power storage apparatus 100 is mounted on a vehicle, for example, the X direction is the front-rear direction of the vehicle and the Y direction is the width direction of the vehicle. An X1 direction is a direction from the rear side of the vehicle to the front side of the vehicle. An X2 direction is a direction from the front side of the vehicle to the rear side of the vehicle. A Y1 direction is a direction from the right side of the vehicle to the left side of the vehicle. A Y2 direction is a direction from the left side of the vehicle to the right side of the vehicle. The Z direction is an up-down (perpendicular) direction. A Z1 direction is a direction from the lower side of the vehicle to the upper side of the vehicle. A Z2 direction is a direction from the upper side of the vehicle to the lower side of the vehicle. In the present disclosure, a Z1 direction is also referred to as an up direction and a Z2 direction is also referred to as a down direction.

The electric power storage apparatus 100 includes a storage case 90, the reinforcement members 81, a plurality of reinforcement members 82, the electric power storage unit 110, the cooling devices 30, cooling pipes 41, 42, a plurality of brackets 60, and a plurality of brackets 70.

The storage case 90 stores the reinforcement members 81, the reinforcement members 82, the electric power storage unit 110, the cooling devices 30, the cooling pipes 41, 42, the brackets 60, and the brackets 70. More specifically, the storage case 90 includes the upper case 91 and a lower case 92. The lower case 92 is disposed lower than the upper case 91. The peripheral section of the upper case 91 is connected to the peripheral section of the lower case 92 by bolts or the like with a seal member in between. The reinforcement members 81, the reinforcement members 82, the electric power storage unit 110, the cooling devices 30, the cooling pipes 41, 42, the brackets 60, and the brackets 70 are stored in a space formed by the upper case 91 and the lower case 92.

The lower case 92 includes a bottom wall 921 and a peripheral wall 922. The peripheral wall 922 stands from the peripheral section of the bottom wall 921. The peripheral wall 922 is formed to have a substantially quadrangular-tube shape. The peripheral wall 922 includes sidewalls 931 to 934. The sidewall 931 and the sidewall 932 are disposed in the Y direction at an interval. The sidewall 932 is disposed on the Y2 side of the sidewall 931. The sidewall 933 and the sidewall 934 are disposed in the X direction at an interval. The sidewall 934 is disposed on the X2 side of the sidewall 933.

The reinforcement members 81, 82 are provided on the lower case 92. Each of the reinforcement members 81, 82 is formed to protrude upward from the bottom wall 921 of the lower case 92. Each of the reinforcement members 81, 82 is fixed (e.g., fastened or welded) to the bottom wall 921. Each of the reinforcement members 81, 82 is, for example, a metal plate-shaped member.

In the present embodiment, the reinforcement members 81 include the four reinforcement members 81. The four reinforcement members 81 are arranged in the X direction at intervals. The four reinforcement members 81 each extend in the Y direction along the bottom wall 921 of the lower case 92. It is to be noted that the number of reinforcement members 81 is not limited to four. It is sufficient if the lower case 92 is provided with the one or more reinforcement members 81.

In the present embodiment, the reinforcement members 82 include the six reinforcement members 82. More specifically, the two reinforcement members 82 are arranged between the reinforcement members 81 in the Y direction at an interval. The reinforcement members 81 are placed side by side in the X direction. Each of the reinforcement members 82 extend in the X direction along the bottom wall 921 of the lower case 92. It is to be noted that the number of reinforcement members 82 is not limited to six. It is sufficient if the lower case 92 is provided with the one or more reinforcement members 82.

The reinforcement members 81 and the reinforcement members 82 define the storage space in the storage case 90 as a plurality of regions (nine regions in the present embodiment). One electric power storage module 10 is disposed in each of the nine regions.

The electric power storage unit 110 includes the electric power storage modules 10. In the present embodiment, the electric power storage modules 10 include the nine electric power storage modules 10. It is to be noted that the number of electric power storage modules 10 is not limited to nine. It is sufficient if the electric power storage unit 110 includes the two or more electric power storage modules 10.

The nine electric power storage modules 10 are disposed in an XY plane in a matrix of 3×3. Specifically, three module columns M each including the three electric power storage modules 10 placed side by side in the Y direction are arranged in the X direction.

Each of the module columns M includes an electric power storage module 10a, an electric power storage module 10b, and an electric power storage module 10c. The electric power storage module 10a is the electric power storage module 10 that is disposed in the middle of the three electric power storage modules 10 of the module column M. The electric power storage module 10b is the electric power storage module 10 that is disposed the closest to the Y2 side among the three electric power storage modules 10 of the module column M. The electric power storage module 10c is the electric power storage module 10 that is disposed the closest to the Y1 side among the three electric power storage modules 10 of the module column M. The electric power storage module 10a and the electric power storage module 10b are adjacent in the horizontal direction (if described in more detail, the Y direction). The electric power storage module 10a and the electric power storage module 10c are adjacent in the horizontal direction (if described in more detail, the Y direction).

The reinforcement member 81 is disposed between the module columns M adjacent in the X direction. More specifically, the reinforcement member 81 is disposed between the electric power storage modules 10 adjacent in the X direction. The reinforcement member 82 is disposed between the electric power storage modules 10 adjacent in the Y direction. The reinforcement member 82 extends between the electric power storage modules 10 adjacent in the Y direction along the bottom wall 921 of the lower case 92.

Each of the electric power storage modules 10 includes a lower module 1 and an upper module 2. The upper module 2 is disposed upper than (on the Z1 side of) the lower module 1. The lower module 1 and the upper module 2 are stacked in the Z direction with the cooling device 30 in between. It is to be noted that each of the electric power storage modules 10 may include the lower module 1 and refrain from including the upper module 2.

When FIG. 3 is referred to, a smoke discharge section 151 is formed lower than the middle of the electric power storage module 10 in the up-down direction. The smoke discharge section 151 discharges gas in the electric power storage module 10. The smoke discharge section 152 is formed upper than the middle of the electric power storage module 10 in the up-down direction. The smoke discharge section 152 discharges gas in the electric power storage module 10. More specifically, the smoke discharge section 151 is formed on the lower surface of each of the lower modules 1. The smoke discharge section 151 discharges gas in the lower module 1. The smoke discharge section 152 is formed on the upper surface of each of the upper modules 2. The smoke discharge section 152 discharges gas in the upper module 2. In the present embodiment, both the smoke discharge section 151 and the smoke discharge section 152 are smoke outlets. In addition, in the present embodiment, the one smoke discharge section 151 is formed on the lower module 1 and the one smoke discharge section 152 is formed on the upper module 2. In addition, in the present embodiment, in a top view of the smoke discharge section 151, the smoke discharge section 151 has an elliptical shape. In addition, in the present embodiment, in a top view of the smoke discharge section 152, the smoke discharge section 152 has an elliptical shape.

Additionally, it is sufficient if the smoke discharge section 151 is formed lower than the middle of the electric power storage module 10 in the up-down direction. The smoke discharge section 151 does not have to be formed on the lower surface of the lower module 1. In addition, the number of smoke discharge sections 151 formed on the electric power storage module 10 is not limited to one. It is sufficient if the number of smoke discharge sections 151 formed on the electric power storage module 10 is one or more. In addition, the shape of the smoke discharge section 151 formed on the electric power storage module 10 is not limited to the shape illustrated in FIG. 3.

In addition, it is sufficient if the smoke discharge section 152 is formed upper than the middle of the electric power storage module 10 in the up-down direction. The smoke discharge section 152 does not have to be formed on the upper surface of the upper module 2. In addition, the number of smoke discharge sections 152 formed on the electric power storage module 10 is not limited to one. It is sufficient if the number of smoke discharge sections 152 formed on the electric power storage module 10 is one or more. In addition, the shape of the smoke discharge section 152 formed on the electric power storage module 10 is not limited to the shape illustrated in FIG. 3.

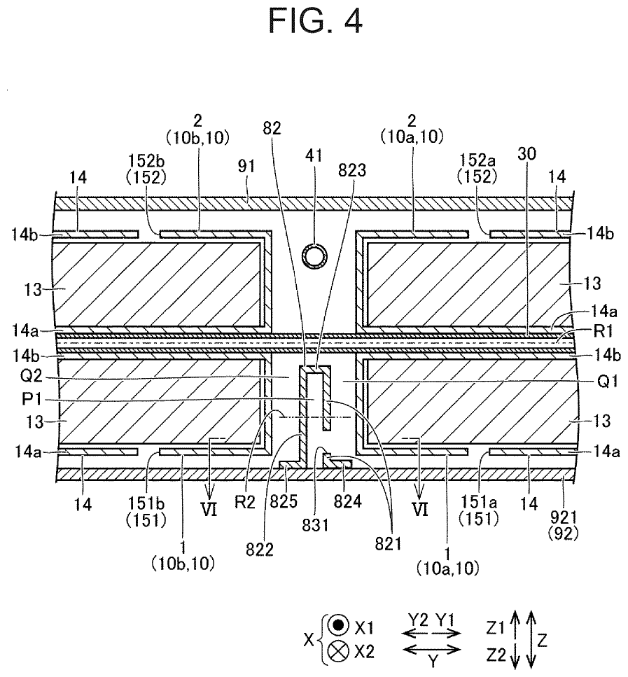

The lower module 1 and the upper module 2 each include a plurality of electric power storage cells 13 (see FIG. 4) and a cell case 14 (see FIG. 4) that stores the electric power storage cells 13. The electric power storage cells 13 are disposed side by side in the X direction. It is to be noted that the electric power storage cells 13 may be disposed side by side in the Y direction.

Each of the electric power storage cells 13 is provided with a cell smoke discharge valve that discharges gas in the electric power storage cell 13 in a case where the internal pressure of the electric power storage cell 13 reaches a predetermined value or more. Gas discharged from each of the electric power storage cells 13 in the lower module 1 is discharged to the outside of the lower module 1 through the smoke discharge section 151. Gas discharged from each of the electric power storage cells 13 in the upper module 2 is discharged to the outside of the upper module 2 through the smoke discharge section 152.

The nine electric power storage modules 10 included in the electric power storage unit 110 are connected in series by a plurality of first bus bars 21, a plurality of second bus bars 22, and a plurality of third bus bars 23. The respective first bus bars 21 electrically connect the electric power storage modules 10 placed side by side in the Y direction to each other. The respective second bus bars 22 electrically connect the lower modules 1 and the upper modules 2 placed side by side in the up-down direction to each other. The respective third bus bars 23 electrically connect the module columns M placed side by side in the X direction to each other.

When FIG. 1 and FIG. 2 are each referred to again, the cooling device 30 is provided for each of the module columns M. That is, in the present embodiment, the cooling devices 30 include the three cooling devices 30. Each of the cooling devices 30 is disposed between the lower modules 1 and the upper modules 2. Each of the cooling devices 30 cools the three electric power storage modules 10 (the electric power storage module 10a, the electric power storage module 10b, and the electric power storage module 10c) included in the module column M by a refrigerant supplied from the cooling pipe 41.

It is to be noted that the number of cooling devices 30 is not limited to three. The number of cooling devices 30 may vary depending on the number of module columns M. In addition, the cooling device 30 may be provided for each of the electric power storage modules 10.

The cooling pipe 41 is a pipe through which a refrigerant to be supplied to each of the cooling devices 30 is transferred. The cooling pipe 42 is a pipe through which a refrigerant to be discharged from each of the cooling devices 30 is transferred. Each of the cooling pipes 41, 42 has a cylindrical shape.

Each of the brackets 60, 70 is formed by using, for example, aluminum. Each of the brackets 60, 70 is provided for each of the module columns M. That is, in the present embodiment, the brackets 60 include the three brackets 60 and the brackets 70 include the three brackets 70. It is to be noted that the number of brackets 60 and the number of brackets 70 are not each limited to three. The number of brackets 60 and the number of brackets 70 may each vary depending on the number of module columns M.

Each of the brackets 60, 70 couples the three electric power storage modules 10 (the electric power storage module 10a, the electric power storage module 10b, and the electric power storage module 10c) in the module column M. In addition, each of the brackets 60, 70 couples the lower module 1 and the upper module 2 for each of the three electric power storage modules 10 in the module column M. Each of the brackets 60, 70 is fixed to the lower case 92 with the reinforcement member 81 in between. That is, the module columns M are fixed to the lower case 92 by the respective brackets 60, 70.

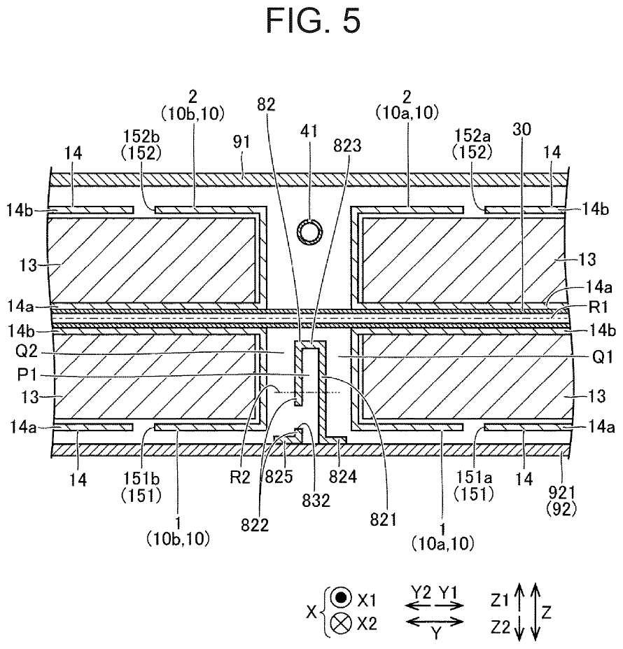

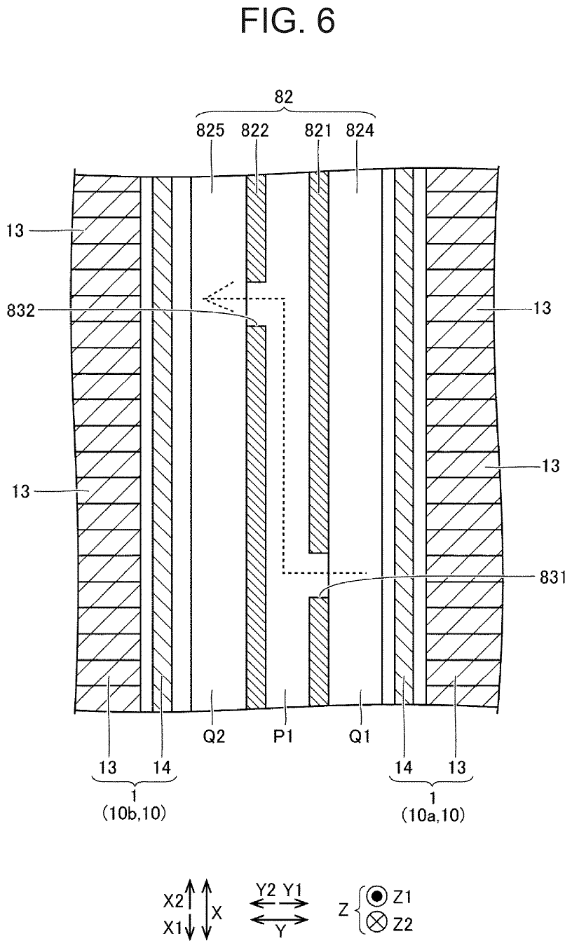

The detailed structure of the reinforcement member 82 will be described with reference to FIG. 4 to FIG. 6. FIG. 4 is a sectional view taken along a line IV-IV in FIG. 2. FIG. 5 is a sectional view taken along a line V-V in FIG. 2. FIG. 6 is a sectional view taken along a line VI-VI in FIG. 4.

When FIG. 4 and FIG. 5 are each referred to, the electric power storage module 10a and the electric power storage module 10b are adjacent in the horizontal direction (if described in more detail, the Y direction). The electric power storage module 10b is disposed on the Y2 side of the electric power storage module 10a. The electric power storage module 10a is an example of a “first electric power storage module” according to the present disclosure and the electric power storage module 10b is an example of a “second electric power storage module” according to the present disclosure.

A two-dot chain line R1 indicates the position of the middle of the electric power storage modules 10 in the up-down direction. That is, the two-dot chain line R1 indicates the position of the middle of the electric power storage module 10a in the up-down direction. In addition, the two-dot chain line R1 indicates the position of the middle of the electric power storage module 10b in the up-down direction. In addition, the two-dot chain line R1 indicates the position of the middle of the electric power storage module 10c (see FIG. 1) in the up-down direction.

A smoke discharge section 151a is the smoke discharge section 151 that discharges gas in the lower module 1 of the electric power storage module 10a. The smoke discharge section 151a is formed lower than the middle of the electric power storage module 10a in the up-down direction. More specifically, the smoke discharge section 151a is formed on the lower surface of the electric power storage module 10a. In the present embodiment, the lower module 1 and the upper module 2 each include the electric power storage cells 13 disposed side by side in the X direction and the cell case 14 that stores the electric power storage cells 13. Each of the cell cases 14 includes a lower wall 14a and an upper wall 14b disposed in the up-down direction (Z direction) at an interval. The smoke discharge section 151a is formed on the lower wall 14a of the cell case 14 of the lower module 1 in the electric power storage module 10a.

A smoke discharge section 152a is the smoke discharge section 152 that discharges gas in the upper module 2 of the electric power storage module 10a. The smoke discharge section 152a is formed upper than the middle of the electric power storage module 10a in the up-down direction. More specifically, the smoke discharge section 152a is formed on the upper surface of the electric power storage module 10a. In the present embodiment, the smoke discharge section 152a is formed on the upper wall 14b of the cell case 14 of the upper module 2 in the electric power storage module 10a.

A smoke discharge section 151b is the smoke discharge section 151 that discharges gas in the lower module 1 of the electric power storage module 10b. The smoke discharge section 151b is formed lower than the middle of the electric power storage module 10b in the up-down direction. More specifically, the smoke discharge section 151b is formed on the lower surface of the electric power storage module 10b. In the present embodiment, the smoke discharge section 151b is formed on the lower wall 14a of the cell case 14 of the lower module 1 in the electric power storage module 10b.

A smoke discharge section 152b is the smoke discharge section 152 that discharges gas in the upper module 2 of the electric power storage module 10b. The smoke discharge section 152b is formed upper than the middle of the electric power storage module 10b in the up-down direction. More specifically, the smoke discharge section 152b is formed on the upper surface of the electric power storage module 10b. In the present embodiment, the smoke discharge section 152b is formed on the upper wall 14b of the cell case 14 of the upper module 2 in the electric power storage module 10b.

The reinforcement member 82 is disposed between the electric power storage module 10a and the electric power storage module 10b. More specifically, the reinforcement member 82 extends between the electric power storage module 10a and the electric power storage module 10b in the X direction along the bottom wall 921 of the lower case 92.

A first space Q1 is formed between the electric power storage module 10 disposed on the Y1 side among the two electric power storage modules 10 disposed with the reinforcement member 82 in between and the reinforcement member 82. A second space Q2 is formed between the electric power storage module 10 disposed on the Y2 side among the two electric power storage modules 10 disposed with the reinforcement member 82 in between and the reinforcement member 82. More specifically, the first space Q1 is formed between the electric power storage module 10a and the reinforcement member 82 and the second space Q2 is formed between the electric power storage module 10b and the reinforcement member 82.

The reinforcement member 82 includes a first wall section 821, a second wall section 822, an upper wall section 823, and flange sections 824, 825. The first wall section 821 and the second wall section 822 are disposed in the Y direction at an interval. The second wall section 822 is disposed on the Y2 side of the first wall section 821. The first wall section 821 faces the electric power storage module 10 disposed on the Y1 side among the two electric power storage modules 10 disposed with the reinforcement member 82 in between. The second wall section 822 faces the electric power storage module 10 disposed on the Y2 side among the two electric power storage modules 10 disposed with the reinforcement member 82 in between. More specifically, the first wall section 821 faces the electric power storage module 10a and the second wall section 822 faces the electric power storage module 10b.

The upper wall section 823 connects the upper ends of the first wall section 821 and the second wall section 822 to each other. The flange section 824 is provided to protrude toward the electric power storage module 10 facing the first wall section 821 from the lower end of the first wall section 821. More specifically, the flange section 824 is provided to protrude toward the electric power storage module 10a from the lower end of the first wall section 821.

The flange section 825 is provided to protrude toward the electric power storage module 10 facing the second wall section 822 from the lower end of the second wall section 822. More specifically, the flange section 825 is provided to protrude toward the electric power storage module 10b from the lower end of the second wall section 822.

The flange sections 824, 825 are fixed to the bottom wall 921 of the lower case 92. The flange sections 824, 825 may be fixed to the bottom wall 921 by fastening members or may be fixed to the bottom wall 921 by welding or the like.

A hollow section P1 is formed between the first wall section 821 and the second wall section 822. More specifically, the first wall section 821, the second wall section 822, the upper wall section 823, the flange sections 824, 825, and the bottom wall 921 of the lower case 92 form the hollow section P1.

A first hole section 831 (see FIG. 4) and a second hole section 832 (see FIG. 5) are formed on the reinforcement member 82. The first hole section 831 and the second hole section 832 each vent gas discharged from the smoke discharge section 151 of one of the two electric power storage modules 10 disposed with the reinforcement member 82 in between to the region in which the other electric power storage module 10 is disposed. More specifically, as illustrated in FIG. 4, the first hole section 831 is formed on the first wall section 821. The first hole section 831 provides communication between the first space Q1 and the hollow section P1. As illustrated in FIG. 5, the second hole section 832 is formed on the second wall section 822. The second hole section 832 provides communication between the second space Q2 and the hollow section P1. In the present embodiment, the one first hole section 831 is formed on the first wall section 821 and the one second hole section 832 is formed on the second wall section 822.

A two-dot chain line R2 indicates the position of the middle of the reinforcement member 82 in the up-down direction. The first hole section 831 and the second hole section 832 are each formed lower than the middle of the reinforcement member 82 in the up-down direction.

When FIG. 6 is referred to, the position of the first hole section 831 and the position of the second hole section 832 are deviated in the direction in which the reinforcement member 82 extends. In the present embodiment, the reinforcement member 82 extends in the X direction. In the present embodiment, the position of the first hole section 831 and the position of the second hole section 832 are thus deviated in the X direction.

FIG. 6 illustrates the flow of gas discharged from the electric power storage module 10a by a dotted arrow. Part of gas discharged from the smoke discharge section 151a (see FIG. 4) of the electric power storage module 10a flows into the first space Q1. Part of the gas flowing into the first space Q1 flows into the hollow section P1 through the first hole section 831. The gas flowing into the hollow section P1 flows to the second space Q2 through the second hole section 832.

In addition, part of gas discharged from the smoke discharge section 151b (see FIG. 4) of the electric power storage module 10b flows into the second space Q2. Part of the gas flowing into the second space Q2 flows into the hollow section P1 through the second hole section 832. The gas flowing into the hollow section P1 flows to the first space Q1 through the first hole section 831.

In general, when gas discharged from the electric power storage module 10 remains in the region in which the electric power storage module 10 is disposed, electrically conductive foreign matter (debris) included in the gas is deposited in the region and thermal influence from the electrically conductive foreign matter causes thermal runaway in the electric power storage module 10. The thermal runaway in the electric power storage module 10 is when temperatures of a plurality of the electric power storage cells 13 in the electric power storage module 10 increase due to a chain reaction and produce smoke.

When FIG. 4 to FIG. 6 are each referred to, in the present embodiment, the first hole section 831 and the second hole section 832 are formed on the reinforcement member 82, thereby causing gas discharged from the smoke discharge section 151 of one (e.g., electric power storage module 10a) of the two electric power storage modules 10 disposed with the reinforcement member 82 in between and electrically conductive foreign matter included in the gas to flow to the region in which the other electric power storage module 10 (e.g., electric power storage module 10b) is disposed. That is, the gas discharged from the smoke discharge section 151 of one of the two electric power storage modules 10 disposed with the reinforcement member 82 in between and the electrically conductive foreign matter included in the gas are restrained from remaining in the region in which the one of the electric power storage modules 10 is disposed. Thermal influence received by the one of the electric power storage modules 10 from the electrically conductive foreign matter included in the gas discharged from the smoke discharge section 151 of the one of the electric power storage module 10 is thus reduced. The electric power storage apparatus 100 according to the present embodiment therefore prevents thermal runaway in the electric power storage module 10.

As described above, in the electric power storage apparatus 100 according to the present embodiment, the first hole section 831 is formed on the first wall section 821 of the reinforcement member 82 disposed between the first electric power storage module (e.g., electric power storage module 10a) and the second electric power storage module (e.g., electric power storage module 10b) and the second hole section 832 is formed on the second wall section 822 of the reinforcement member 82. The gas discharged from the smoke discharge section 151 of the first electric power storage module and the electrically conductive foreign matter included in the gas are thus restrained from remaining in the region in which the first electric power storage module is disposed. Thermal influence received by the first electric power storage module from the electrically conductive foreign matter included in the gas discharged from the smoke discharge section 151 of the first electric power storage module is therefore reduced. The electric power storage apparatus 100 according to the present embodiment thus makes it possible to prevent thermal runaway in the electric power storage module 10.

In addition, the electric power storage apparatus 100 according to the present embodiment prevents thermal runaway in the first electric power storage module. Thus, the internal pressure of the electric power storage apparatus 100 is also prevented from increasing. Accordingly, the electric power storage apparatus 100 according to the present embodiment makes it possible to prevent a seal member connecting the upper case 91 and the lower case 92 from being cut open.

In addition, in the electric power storage apparatus 100 according to the present embodiment, the smoke discharge section 151 of a first electric power storage module (e.g., electric power storage module 10a) is formed lower than the middle of the first electric power storage module in the up-down direction. In addition, in the electric power storage apparatus 100 according to the present embodiment, the first hole section 831 and the second hole section 832 are each formed lower than the middle of the reinforcement member 82 in the up-down direction. It is thus possible to cause gas discharged from the smoke discharge section 151 of the first electric power storage module and electrically conductive foreign matter included in the gas to efficiently flow to the second space Q2 formed between a second electric power storage module (e.g., electric power storage module 10b) and the reinforcement member 82. Thermal influence received by the first electric power storage module from the electrically conductive foreign matter included in the gas discharged from the smoke discharge section 151 of the first electric power storage module is therefore further reduced. The electric power storage apparatus 100 according to the present embodiment thus makes it possible to further prevent thermal runaway in the electric power storage module 10.

In addition, in the electric power storage apparatus 100 according to the present embodiment, the position of the first hole section 831 and the position of the second hole section 832 are deviated in the direction in which the reinforcement member 82 extends. Electrically conductive foreign matter included in gas discharged from the smoke discharge section 151 of a first electric power storage module (e.g., electric power storage module 10a) is thus prevented from directly hitting a second electric power storage module (e.g., electric power storage module 10b). In addition, the deviation between the position of the first hole section 831 and the position of the second hole section 832 in the direction in which the reinforcement member 82 extends decreases the flow rate of the gas discharged from the smoke discharge section 151 of the first electric power storage module and the flow rate of the electrically conductive foreign matter included in the gas. Thermal influence received by the second electric power storage module from the electrically conductive foreign matter included in the gas discharged from the smoke discharge section 151 of the first electric power storage module is therefore reduced. The electric power storage apparatus 100 according to the present embodiment thus makes it possible to prevent chain-reaction thermal runaway between the first electric power storage module and the second electric power storage module.

### First Modification Example

The number of first hole sections 831 formed on the first wall section 821 is not limited to one. It is sufficient if the number of first hole sections 831 formed on the first wall section 821 is one or more. The number of second hole sections 832 formed on the second wall section 822 is not limited to one. It is sufficient if the number of second hole sections 832 formed on the second wall section 822 is one or more.

### Second Modification Example

The position of the first hole section 831 is not limited to the positions illustrated in FIG. 4 to FIG. 6. The first hole section 831 may be formed at any position on the first wall section 821. In addition, the position of the second hole section 832 is not limited to the positions illustrated in FIG. 4 to FIG. 6. The second hole section 832 may be formed at any position on the second wall section 822. Thus, the first hole section 831 and the second hole section 832 may be each formed in the middle of the reinforcement member 82 in the up-down direction or may be each formed upper than the middle of the reinforcement member 82 in the up-down direction. In addition, the position of the first hole section 831 and the position of the second hole section 832 do not have to be deviated in the direction in which the reinforcement member 82 extends.

### Third Modification Example

The first hole section 831 and the second hole section 832 are not formed on the reinforcement member 82, but a hole section that vents gas discharged from the smoke discharge section 151 of one of the two electric power storage modules 10 disposed with the reinforcement member 81 in between to the region in which the other electric power storage module 10 is disposed may be formed on the reinforcement member 81 (see FIG. 1).

In addition, the first hole section 831 and the second hole section 832 may be formed on the reinforcement member 82 and also the hole section that vents gas discharged from the smoke discharge section 151 of one of the two electric power storage modules 10 disposed with the reinforcement member 81 in between to the region in which the other electric power storage module 10 is disposed may be formed on the reinforcement member 81. The nine regions in the storage case 90 are thus coupled and the dispersion effects of electrically conductive foreign matter included in the gas discharged from the smoke discharge section 151 thus increase. Thus, thermal runaway in the electric power storage module 10 is further prevented.

### Fourth Modification Example

The smoke discharge section 151 may be a cell smoke discharge valve provided to the electric power storage cell 13. In addition, the smoke discharge section 151 may be a smoke outlet covered with a resin member or the like. In a case where the smoke outlet is covered with the resin member or the like, the resin member is configured to be broken at high temperature or high pressure.

The smoke discharge section 152 may be a cell smoke discharge valve provided to the electric power storage cell 13. In addition, the smoke discharge section 152 may be a smoke outlet covered with a resin member or the like. In a case where the smoke outlet is covered with the resin member or the like, the resin member is configured to be broken at high temperature or high pressure.

### Fifth Modification Example

The electric power storage cell 13 may be a laminated cell. The laminated cell includes a cell body and a laminating film that wraps the cell body. The edge sections of the laminating film are welded to each other.

The embodiment disclosed herein should be understood as an example in all respects, but should not be understood as being restrictive. The scope of the present disclosure is demonstrated by the claims instead of the description above. The scope of the present disclosure is intended to include the equivalents to the claims and all modifications within the scope of the claims.

What is claimed is:

1. An electric power storage apparatus comprising:
a first electric power storage module;
a second electric power storage module adjacent to the first electric power storage module; and
a reinforcement member disposed between the first electric power storage module and the second electric power storage module, wherein
a smoke discharge section configured to discharge gas in the first electric power storage module is provided lower than a middle of the first electric power storage module in an up-down direction,
the reinforcement member includes a first wall section facing the first electric power storage module and a second wall section facing the second electric power storage module,
a hollow section is provided between the first wall section and the second wall section,
a first space is provided between the first electric power storage module and the reinforcement member and a first hole section is provided on the first wall section, the first hole section providing communication between the first space and the hollow section,
a second space is provided between the second electric power storage module and the reinforcement member, and
a second hole section is provided on the second wall section, the second hole section providing communication between the second space and the hollow section.

2. The electric power storage apparatus according to claim 1, wherein the first hole section and the second hole section are each provided lower than a middle of the reinforcement member in the up-down direction.

3. The electric power storage apparatus according to claim 1, further comprising a storage case configured to store the first electric power storage module and the second electric power storage module, the storage case including an upper case and a lower case, wherein
the reinforcement member extends between the first electric power storage module and the second electric power storage module along a bottom wall of the lower case, and
a position of the first hole section and a position of the second hole section are deviated in a direction in which the reinforcement member extends.
